(19) United States
(12) Patent Application Publication
(10) Pub. No.: US 2025/0355441 A1
(43) Pub. Date: Nov. 20, 2025

(54) MANAGING LOADED CARGO IN A VEHICLE

(71) Applicant: Volvo Truck Corporation, Göteborg (SE)

(72) Inventors: Arnaud BRUN, Lyon (FR); Fanette SEVENIER, Courzieu (FR)

(21) Appl. No.: 19/185,604

(22) Filed: Apr. 22, 2025

(30) Foreign Application Priority Data
May 14, 2024 (EP) 24175577.6

(51) Int. Cl. G05D 1/617; G05D 1/246; G05D 105/28; G05D 109/10

(52) U.S. Cl. CPC G05D 1/618; G05D 1/246; G05D 2105/28; G05D 2109/16

(57) ABSTRACT

A computer system comprising processing circuitry is disclosed. The processing circuitry is configured to obtain sensing data from a sensor monitoring a cargo space of a vehicle; determine, based on the sensing data, that at least a portion of a cargo in the cargo space is moved a threshold distance of the cargo space during operation of the vehicle; determine at least one preventive action to be carried out by the vehicle to prevent further movement of the cargo with respect to the threshold distance, the at least one preventive action comprising a driving route; and control the vehicle to at least partially carry out the at least one preventive action.

### PRIORITY APPLICATIONS

The present application claims priority to European Patent Application No. 24175577.6, filed on May 14, 2024, and entitled “MANAGING LOADED CARGO IN A VEHICLE,” which is incorporated herein by reference in its entirety.

### TECHNICAL FIELD

The disclosure relates generally to cargo management. In particular aspects, the disclosure relates to managing loaded cargo in a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In the field of vehicle cargo management, existing systems have often been limited to the passive monitoring of cargo within a cargo space, alerting users to movement without providing actionable responses. These systems lack the capability to adapt to the varying conditions of transit, such as changes in vehicle speed, road terrain, and driving maneuvers, which can all influence cargo stability. The static nature of these solutions means they do not consider the real-time operational context of the vehicle, potentially leading to inefficient and ineffective management of cargo movement. Furthermore, the implementation of sensor technology in these systems typically does not extend beyond simple detection, failing to offer preventive measures or control strategies that could mitigate the risk of cargo displacement. This gap highlights a need for an intelligent, dynamic approach to cargo management that can anticipate and actively respond to potential cargo shifts.

### SUMMARY

According to a first aspect of the disclosure, there is provided a computer system comprising processing circuitry. The processing circuitry is configured to obtain sensing data from a sensor monitoring a cargo space of a vehicle; determine, based on the sensing data, that at least a portion of a cargo in the cargo space is moved a threshold distance of the cargo space during operation of the vehicle; determine at least one preventive action to be carried out by the vehicle to prevent further movement of the cargo with respect to the threshold distance, the at least one preventive action comprising a driving route; and control the vehicle to at least partially carry out the at least one preventive action. The first aspect of the disclosure may seek to mitigate the risk of cargo damage and improve safety by actively managing cargo movement at a vehicle's cargo space through sensing and autonomous corrective actions. A technical benefit may include enhanced transportation efficiency by reducing the need for manual cargo checks and potential transport delays, as well as the improvement of vehicle operation with regards to route planning and cargo stability.

Optionally in some examples, including in at least one preferred example, the processing circuitry is configured to determine the driving route by at least selecting or omitting one or more route segments from the driving route. A technical benefit may include the ability to improve the driving route for safety and efficiency by avoiding areas that may cause cargo movement or disrupt vehicle operation.

Optionally in some examples, including in at least one preferred example, the processing circuitry is further configured to at least select or omit said one or more route segments based on one or more of a vehicle type of the vehicle, a road condition for the driving route, topology data for the driving route, traffic data for the driving route, and safety and regulatory data for the driving route. A technical benefit may include the customization of the driving route based on specific vehicle capabilities and current road conditions, ensuring a safer transit for the cargo.

Optionally in some examples, including in at least one preferred example, the at least one preventive action comprises a suspension control action, a speed control action, an acceleration control action, a brake control action, a yaw control action, a turn control action, an anti-slip control action, or a hydraulic leveling action, wherein controlling the vehicle to at least partially carry out the preventive action causes counteraction of further movement of the cargo. A technical benefit may include the direct mitigation of factors that could lead to cargo instability through targeted vehicle adjustments.

Optionally in some examples, including in at least one preferred example, the processing circuitry is further configured to, in response to determining that at least a portion of the cargo in the cargo space is moved a threshold distance with respect to the cargo space during operation of the vehicle, cause emission of one or more of an audible alert, visual cue, and tactile indicator. A technical benefit may include the immediate notification of cargo movement to the driver or environment, allowing for prompt corrective measures to be taken.

Optionally in some examples, including in at least one preferred example, the processing circuitry is configured to control the vehicle to at least partially carry out the at least one preventive action by causing autonomous driving of the vehicle to follow the determined driving route. A technical benefit may include reducing the driver's workload by allowing the vehicle to automatically adjust its path to maintain cargo safety.

Optionally in some examples, including in at least one preferred example, the processing circuitry is configured to control the vehicle to at least partially carry out the at least one preventive action by transmitting the driving route to a driver of the vehicle via a user interface. A technical benefit may include keeping the driver informed of a recommended route for cargo stability, enhancing driver control and decision-making.

Optionally in some examples, including in at least one preferred example, the processing circuitry is further configured to determine at least one preventive action to be carried out by the vehicle to prevent further movement of the cargo with respect to the threshold distance by identifying a discrepancy between reference sensing data, indicating an expected safe placement of the cargo, and the sensing data. A technical benefit may include the accurate detection of cargo displacement and the timely initiation of corrective actions, reducing the risk of cargo damage.

Optionally in some examples, including in at least one preferred example, the sensor monitors an outer boundary of the cargo space, wherein the threshold distance pertains to the outer boundary. A technical benefit may include the precise monitoring of cargo position relative to the cargo space boundaries, ensuring the cargo remains within a defined safe area.

Optionally in some examples, including in at least one preferred example, the sensor comprises a plurality of sensors, each one of the plurality of sensors monitoring a respective outer boundary comprising at least two of a first outer lateral boundary, a second outer lateral boundary different from the first outer lateral boundary, a rear outer boundary, and a front outer boundary, wherein the threshold distance pertains to each of the monitored outer boundaries. A technical benefit may include comprehensive coverage of the cargo space for enhanced detection of cargo movement in any direction.

Optionally in some examples, including in at least one preferred example, the processing circuitry is further configured to set the threshold distance based on one or more of a type of cargo, a type of cargo space, and a mounting position of the sensor. A technical benefit may include the adaptable setting of safety thresholds to accommodate various cargo types and configurations, improving the versatility of the cargo monitoring system.

According to a second aspect of the disclosure, there is provided a vehicle comprising the computer system of the first aspect. The second aspect of the disclosure may seek to integrate cargo monitoring capabilities into the vehicle itself to provide a comprehensive solution that ensures cargo integrity and addresses vehicle operational challenges. A technical benefit may include the seamless incorporation of the monitoring system into the vehicle's architecture, allowing for more robust and responsive cargo management, as well as the potential for improved vehicle handling and safety due to the ability to preemptively adjust to cargo movement.

According to a third aspect of the disclosure, there is provided a computer-implemented method. The method comprises obtaining, by processing circuitry of a computer system, sensing data from a sensor monitoring a cargo space of a vehicle; determining, by the processing circuitry, based on the sensing data, that at least a portion of a cargo in the cargo space is moved a threshold distance of the cargo space during operation of the vehicle; determining, by the processing circuitry, at least one preventive action to be carried out by the vehicle to prevent further movement of the cargo with respect to the threshold distance, the at least one preventive action comprising a driving route; and controlling, by the processing circuitry, the vehicle to at least partially carry out the at least one preventive action. The third aspect of the disclosure may seek to mitigate the risk of cargo damage and improve safety by actively managing cargo movement at a vehicle's cargo space through sensing and autonomous corrective actions. A technical benefit may include enhanced transportation efficiency by reducing the need for manual cargo checks and potential transport delays, as well as the improvement of vehicle operation with regards to route planning and cargo stability.

According to a fourth aspect of the disclosure, there is provided a computer program product comprising program code for performing, when executed by processing circuitry, the method of the third aspect. The fourth aspect of the disclosure may seek to provide a digital solution in the form of a computer program product that, when implemented, equips the vehicle's processing circuitry with the necessary software to execute the advanced cargo monitoring and management method. A technical benefit may include the flexibility of software deployment across different vehicle systems, allowing for updates and enhancements to be made without the need for physical modifications to the vehicle, leading to improved adaptability and scalability of the cargo monitoring system.

According to a fifth aspect of the disclosure, there is provided a non-transitory computer-readable storage medium comprising instructions, which when executed by processing circuitry, cause the processing circuitry to perform the method of the third aspect. The fifth aspect of the disclosure may seek to offer a tangible medium that stores the executable instructions for the cargo management method, ensuring that the vehicle's processing circuitry can reliably perform the necessary steps to monitor and respond to cargo movement. A technical benefit may include the reliability and security afforded by having a dedicated storage medium, which ensures consistent performance of the cargo monitoring system and reduces the dependency on external networks or systems that might be susceptible to connectivity issues or cyber threats.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary side view illustration of a vehicle comprising a tractor unit and a trailing unit with a cargo space according to one example.

FIG. 2 is an exemplary top view illustration of a vehicle comprising a tractor unit and a trailing unit with a cargo space according to one example.

FIG. 3 is an exemplary schematic block diagram of exemplary preventative actions.

FIG. 4 is an exemplary schematic block diagram of exemplary data upon which a threshold distance can be based.

FIG. A is an exemplary top view illustration of an operational scenario of a vehicle according to one example.

FIG. 5B shows the illustration of FIG. 5A where cargo has moved beyond a threshold distance in a lateral direction from the cargo space according to one example.

FIG. 5C shows the illustration of FIG. 5B where a preventive action has been at least partially carried out for counteracting the cargo movement.

FIG. 6A is an exemplary top view illustration of an operational scenario of a vehicle according to one example.

FIG. 6B shows the illustration of FIG. 6A where cargo has moved beyond a threshold distance in two lateral directions from the cargo space according to one example.

FIG. 6C shows the illustration of FIG. 6B where a preventive action has been at least partially carried out for counteracting the cargo movement.

FIG. 7 is an exemplary top view illustration of an operational scenario of a vehicle according to one example where cargo has moved beyond a threshold distance in a rear direction from the cargo space according to one example.

FIG. 8A is an exemplary top view illustration of an operational scenario of a vehicle according to one example.

FIG. 8B shows the illustration of FIG. 8A where cargo has moved beyond a threshold distance a front direction from the cargo space according to one example.

FIG. 8C shows the illustration of FIG. 8B where a preventive action has been at least partially carried out for counteracting the cargo movement.

FIG. 9 is a schematic diagram of a computer system for implementing examples disclosed herein according to one example.

FIG. 10 is a schematic flowchart of a computer-implemented method for implementing examples disclosed herein according to one example.

FIG. 11 is a schematic flowchart of a computer-implemented method for implementing examples disclosed herein according to one example.

FIG. 12 is a schematic diagram of a computer system for implementing examples disclosed herein according to one example.

### DETAILED DESCRIPTION

The detailed description set forth below provides information and examples of the disclosed technology with sufficient detail to enable those skilled in the art to practice the disclosure.

The present disclosure seeks to address the problem of unaddressed cargo movement within a vehicle's cargo space during transit, which can lead to cargo damage, compromised safety, and inefficiency in transport operations. It addresses this issue by employing approaches that not only detects cargo movement through sensor data but also proactively determines and executes preventive actions to stabilize the cargo and prevent further undesired movement. The computer system achieves this by first obtaining sensing data from sensors being strategically placed. These sensors monitor the position and movement of the cargo, preferably in real-time. When the system identifies that cargo has moved with respect to a pre-set threshold distance, indicating a potential risk, it then determines suitable preventive actions. These actions may include adjusting the driving route of the vehicle, modifying speed, or implementing other vehicle control measures. By doing so, the system actively works to mitigate any additional movement of the cargo that may result from the vehicle's operation or external factors such as road conditions.

The potential benefits of this system are multi-fold. The system may improve cargo safety by actively preventing cargo shifts that could lead to damage or loss. The system may enhance transport efficiency by reducing the need for manual cargo checks and potential transport delays, and may contribute to overall road safety by maintaining vehicle stability. Additionally, since the system preferably operates in real-time, the system can respond to dynamic changes in the vehicle's environment and operation, making it adaptable and responsive to various transit conditions. Compared to the prior art, the subject matter discussed in the present disclosure moves beyond mere detection of cargo movement by the integration of a responsive action component within the vehicle's control system. The system leverages sensor data not just for monitoring but for active intervention, offering a more comprehensive and automated solution to cargo management.

FIG. 1 depicts an illustrative example of vehicle 10, which is shown as a combination vehicle comprising a tractor unit 12 and a single trailing unit 14. The vehicle 10 further includes a cabin 16 for the driver, which comprises the necessary controls and interfaces for operating the vehicle 10. In alternative configurations, the vehicle 10 could be a rigid truck or a more complex assembly involving additional trailing units or a combination of a vehicle combination and a rigid truck. The flexibility in the type of vehicle allows for a variety of cargo transportation scenarios.

The vehicle 10, in this example more specifically the trailing unit 34 includes a cargo space 20. The cargo space 20 is adapted to accommodate one or more pieces of cargo 24. The cargo space 20 can be versatile and adapted to accommodate various types of cargo 24. Examples of such cargo 24 could include construction materials, machinery, palletized goods, containers, or even packaged bulk items like gravel or agricultural produce. The nature of the cargo 24 may dictate the configuration of the cargo space 20, which could include adjustable shelving, tie-down points, and partitions to secure and separate items of differing sizes, weights, and shapes. In the example shown, three pieces of cargo Aire placed within the cargo space 2Q but this is merely illustrative, and the actual number, arrangement, and nature of the cargo can vary widely.

The trailing unit 34 as illustrated, is an open trailer, which is a common configuration for transporting goods that do not require an enclosed space or that are too large or irregularly shaped for standard enclosed trailers. In examples where a rigid truck is employed, an open portion can serve a similar purpose. The open trailer or the open portion of the rigid truck can be secured with a tarpaulin, which may either partially or fully enclose a cargo space 20, providing protection from environmental elements while still allowing for ease of access when loading and unloading cargo 24.

The vehicle 10 also includes one or more systems that can interact with the cargo space 20. The term “interact” shall in this sense be broadly interpreted, and can reflect any type of e.g. electrical or mechanical system that can affect how the cargo 24 is positioned in the cargo space 20. By way of example, such systems may include a suspension system 110, a braking system 112, a stability system 114, a steering system 116, an anti-slip system 118, or a hydraulic system 120. For instance, the cabin 16 could be equipped with monitoring systems that receive data from sensors placed within the cargo space 20, allowing the driver to be aware of the status of the cargo 24 during transport.

The vehicle 10 comprises a sensor 30. As will be described in further detail in the present disclosure, the arrangement location and orientation of the sensor 30 can vary depending on what is being monitored. Generally, however, the sensor 30 monitors the cargo space 20. In certain embodiments, the sensor 30 monitors outer boundaries 22 of the cargo space 20, such as from a location exterior to the cargo space 20. While only one sensor 30 is shown in the present example other sensor configurations for a vehicle can be realized. For example, the vehicle 10 may include sensor arrangements having one or more sensors arranged at any suitable location with respect to the vehicle 10, such as at the tractor unit 12 or the trailer unit 14, a wheel portion, and the like.

The sensor 30 may include motion sensors, cameras, lidars, radars, ultrasonic sensors, infrared sensors, accelerometers, gyroscopes, magnetometers, or other types of sensor units that can detect when the cargo 24 moves with respect to a predefined threshold distance of the cargo space 20. The sensing data depends on what type of sensor technology is employed. For instance, sensors including cameras will return image data as the sensing data. The sensor 30 may in this example sense the surroundings of the vehicle 10, such as one or more meters from the outer boundaries 22 of the cargo space 20. The range and responsiveness of the sensor 30 may depend on sensor type, sensor location, lens type, image sensor resolution, lighting conditions, ambient conditions (e.g., weather, humidity, fogginess), conditions of electronic components, potential obstructions in the field of view, latencies in computer systems, etc.

In some examples, the sensor 30 is a smart sensor configured to process sensed information and make a detection decision related to a detection of an object. The smart sensor may comprise a microcontroller, processor (e.g. PLC, CPU, DSP), FPGA, ASIC or any other suitable digital and/or analog circuitry capable of processing sensing data. The smart sensor may further comprise a memory implemented in any known memory technology, including but not limited to E(E)PROM, S(D)RAM or flash memory. The memory may be integrated with or internal to the microcontroller/processor/circuitry.

In other examples, the sensor 30 is a sensor not capable of processing information itself. Unlike smart sensors, which have built-in processing capabilities to interpret and analyze data, “dumb” sensors or “passive” sensors are devices that detect and measure physical properties or phenomena without any processing or interpretation of the sensing data being collected. These sensors typically generate raw analog or digital signals that need to be processed by external systems or devices to derive meaningful information or insights. Hybrids of smart sensors and dumb sensors can also be envisaged in some examples.

The sensor 30 may be operatively connected (e.g., wired or wirelessly) to suitable devices, systems and features of the vehicle 10. The wireless interface and associated communication protocols may be based on any known communication technology known in the art, such as one or more of HTTP(S), TCP/IP, UDP, FTP, SMTP, DNS, DHCP, SSH, POP3, SCP, NFS, SFTP, ICMP, ARP, RTP, RTCP, IEEE 1202.11, IEEE 1202.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any form of proximity-based device-to-device radio communication, LTE Direct, W-CDMA/HSPA, GSM, UTRAN, LTE, IPv4, IPv6, 6LoWPAN, IrDA, or 5G NR. Wired interfaces may include CAN, Ethernet, FlexRay, or the like.

To address the problem of uncontrolled cargo movement, the vehicle 10 is equipped with a computer system 100 that includes processing circuitry 102. The processing circuitry 132 is configured to obtain sensing data from the sensor 30 (or sensors, in plural, where there are many sensors). Upon detecting that at least a portion of the cargo 24 in the cargo space 20 is moved a threshold distance with respect to cargo space 24 during operation of the vehicle 1Q based on the sensing data, the processing circuitry 12 is configured to determine preventive actions. Carrying out the preventive action would result in further movement of the cargo 24 with respect to the threshold distance. The processing circuitry 132 is then further configured to control the vehicle 10 to at least partially carry out the preventive action that was determined.

The threshold distance of the cargo space 20 refers to a predefined limit or boundary related to the cargo space 20 of the vehicle 10. Movement of cargo with respect to this predefined limit or boundary is considered potentially unsafe or undesirable. In some examples, the threshold distance of the cargo space 20 is set based on outer boundaries of the cargo space 20, while in other examples the threshold distance of the cargo space 20 is set based on boundaries within the cargo space 20 (for example expected safe placements within the cargo space 20). Depending on how the threshold distance is set, different sensor arrangements can be envisaged. To this end, threshold distances set within the cargo space 20 typically necessitate sensor arrangements in the interior of the cargo space 20, especially in examples where the cargo space 20 is an enclosure. Correspondingly, threshold distances set relating to the outer boundaries of the cargo space 20 can involve interior and/or exterior sensor arrangements. The threshold distance acts as a trigger point for the sensor 30, indicating when preventive measures should be considered to stabilize the cargo and prevent it from moving further or exiting the designated safe zone within the cargo space. The threshold distance may be set by the processing circuitry 102 via the sensor 30.

That at least a portion of the cargo 24 is moved the threshold distance of the cargo space 20 describes a situation where one or more items of cargo 24 have shifted to such an extent that the pre-established threshold distance is violated. This implies that the cargo 24 is no longer within the safe containment area as initially intended, potentially leading to compromised security, stability, or integrity of the cargo 24, and potentially increasing the risk of damage to the cargo 24 itself, the vehicle 10, or posing a safety hazard to the operational environment. Cargo shifting with respect to the threshold distance can occur due to a plurality of interconnected factors. For instance, cargo 24 that is not secured tightly enough can easily jostle or shift as the vehicle 10 accelerates, decelerates, or maneuvers over uneven road surfaces. This movement is further exacerbated during aggressive driving actions such as sharp turns or heavy braking, which exert additional lateral or longitudinal forces on the cargo 24. Moreover, environmental factors, like wind resistance acting on a tear in a tarpaulin, can also lead to cargo displacement. Packaging that fails to adequately contain the cargo 24 adds to the risk, as items may move around if not properly restrained. Driving on an incline or through hilly terrain can cause the cargo to gravitate towards the lower end of the vehicle 10, and any external impacts from collisions or road debris can result in sudden and forceful cargo movement. In more severe cases, such as a vehicle rollover, the cargo 24 is almost certain to shift significantly. Each of these scenarios highlights the challenges in maintaining cargo stability and the need for a robust system to monitor and respond to potential cargo movement.

The vehicle operation may encompass all aspects of a functioning and maneuvering of the vehicle 10 while in transit. This includes driving actions such as starting, stopping, accelerating, decelerating, steering, and navigating along a route, as well as operational aspects like the use of braking systems, suspension adjustments, and other vehicle controls that can affect movement of the cargo 24. The vehicle operation may be influenced by the driver's inputs, environmental conditions, vehicle condition, road characteristics, and in the context of modern vehicles, automated systems designed to assist or take over certain driving functions.

The preventive action to be carried out by the vehicle 10 refers to specific measures or maneuvers that the vehicle 10 can perform to counteract the detected movement of cargo 24 based on the sensing data and prevent further displacement. The preventive action comprises a driving route which the vehicle 10 is taking or will take during operation. Preventing further displacement may be to maintain the cargo 24 in place, and preferably also to cause it to be repositioned back within acceptable limits defined by the threshold distance. The processing circuitry 132 may be configured to determine the preventive actions based on the nature and extent of the cargo movement.

“At least partially carrying out the preventive action” means that the processing circuitry 102 begins to implement the determined preventive measures to address the cargo movement issue. The term “at least partially” acknowledges that the full scope of the preventive action may involve a series of steps or adjustments, and the process might be initiated and executed progressively and/or part of the process may involve manual input from the driver. For example, if the preventive action includes a change in route, the vehicle 10 may begin to alter its course immediately upon command but may not complete the route change until a safe opportunity arises. This term captures the initiation and ongoing implementation of the preventive measures, even if they are not fully completed instantaneously.

In some examples, the preventive action may be determined by identifying a discrepancy between reference sensing data and the sensing data. In these examples, the processing circuitry 102 relies on a comparison between two sets of data: reference sensing data, which represents the known and safe placement of the cargo 24 for example representing a safe placement before the vehicle begins operation, and live sensing data collected during the operation. The reference sensing data serves as a standard or baseline for cargo placement within the vehicle's 10 cargo space 20. This baseline can be established through various means such as visual imaging, weight distribution sensors, or spatial mapping technologies, for example before the vehicle 10 embarks on its route, optionally via the sensor 30. The sensor 30 then continuously or periodically captures sensing data during the vehicle's operation to monitor the current state of the cargo 24. By comparing the (preferably real-time) sensing data with the reference data, the processing circuitry 102 can discern any significant discrepancies that may indicate movement of the cargo 24. This comparison may allow identifying genuine shifts in cargo position, rather than false positives that might otherwise trigger unnecessary preventive actions. Such false positives can occur due to the normal vibrations and movements inherent in vehicle operation, which do not necessarily pose a risk to cargo stability. This may ensures that preventive actions are only taken when there is a verified risk of cargo instability, thereby improving the vehicle's 10 operation and ensuring the safety and integrity of the cargo throughout the transit period. These examples may be particularly useful for transporting oversized or irregularly shaped cargo 24 that do not conform to standard cargo dimensions, providing a tailored and reliable solution for a wide range of transportation needs.

In some examples, the preventive action may be partially carried out by causing autonomous driving of the vehicle 10 to follow the determined driving route. The preventive action involving autonomous driving requires the vehicle 10 to have advanced driver-assistance systems (ADAS) and potentially higher levels of automation. This would necessitate a combination of sensors such as cameras, radar, and LiDAR, alongside GPS and mapping technology to accurately determine the vehicle's 10 location and the environment around it. The processing circuitry 102 is configured to interpret the data from these sensors to navigate the determined driving route without human intervention, including steering, speed, and braking, to maintain the stability of the cargo 24. This may offer benefits relating to increased safety, as the vehicle 10 can make rapid, precise adjustments that might be too challenging for a human driver, particularly in complex or hazardous driving conditions. It can also allow for more consistent adherence to the determined driving route, reducing the potential for errors that could lead to cargo movement.

In some examples, the preventive action may be partially carried out by transmitting the driving route to a driver of the vehicle 10. This may be done via a user interface 18 for example the vehicle dashboard or infotainment system. Transmitting the driving route to the driver as a preventive action may leverages the user interface 18 that could be integrated into the vehicle 10. The user interface 18 may display the determined driving route, optionally along with any necessary alerts or recommendations for route changes. The driver would then manually follow these directions to stabilize the cargo 24. To accomplish this, the vehicle 10 involves software capable of converting the sensor and data inputs into clear, actionable driving instructions for the driver. This could include visual maps, auditory commands, or haptic feedback. Benefits of this approach may be that it keeps the driver engaged and informed about the best course of action, combining the data-driven recommendations with the driver's situational awareness and experience. It may allow for a flexible response to unpredictable roads, with the driver having the final say on vehicle control.

A combination of manual and autonomous partial conduct of the preventive action may also be envisaged.

In some examples, the processing circuitry 132 may be further configured to, in response to a cargo 24 moving with respect to the threshold distance, cause emission of a noticeable indicator. This may be done via control of a device, such as a display device in the form of visual cue, a speaker in the form of an audible alert, or a force feedback device in the form of a tactile indicator. The indicator may serve as information that an unsafe cargo condition is detected. The indicator may be emitted inside the cabin 16, for example via the user interface 18 to warn the driver. The indicator may additionally or alternatively be emitted into an external environment, to warn other drivers, pedestrians, or the like. This may be done by activating warning lights, blinkers or other vehicle lights, causing activation of a car horn, or the like.

The sensing data may be able to provide information pertaining to translational movement and/or rotational movement of the cargo 24. Detecting rotational movement may be relevant for stacked or irregularly shaped cargo 24. Rotational movements involve the cargo 24 tilting or rotating around an axis, which could pose a risk in terms of stability and safety. To this end, the threshold distance may pertain to rotational boundaries as well as translational boundaries. In examples where cargo 24 is stacked, the upper layers might rotate due to dynamic forces such as sharp turns or sudden stops, thus increasing the risk of toppling. The detection of rotational movement may necessitate the sensor 30 being capable of providing information pertaining to angular displacement and rotational velocity. The preventive action may differ depending on whether cargo movement violates a threshold distance pertaining to a translational boundary or a rotational boundary. By incorporating the capability to detect both translational and rotational movements and understanding the distinct risks associated with each, a comprehensive approach to maintaining cargo safety can be ensured.

While not explicitly shown in FIG. 1 the vehicle 10 may involve one or more auxiliary systems and devices designed to gather data to be used for the determination of the preventive action. By way of example, such systems may include one or more of a GPS system, IMU(s), weather sensors onboard or linked to the vehicle 10, telematics system, camera systems and other road condition monitoring equipment, weight sensors, stability control system, fleet management system, lidar, radar, communication system, such as vehicle-to-everything (V2X), and onboard diagnostic system.

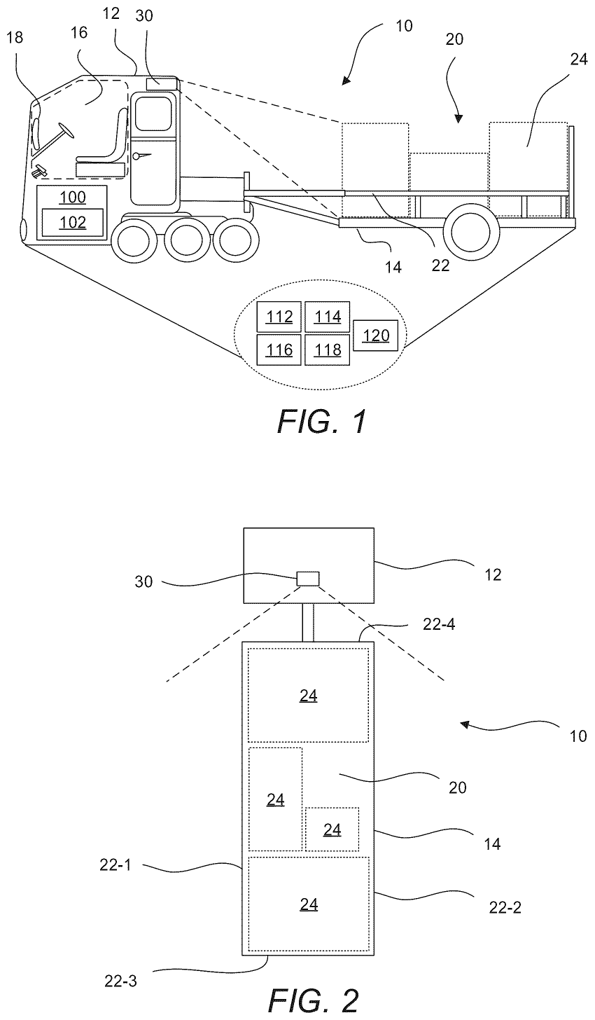

FIG. 2 schematically illustrates a vehicle 10 according to one exemplary top view. The vehicle 10 may be the same vehicle 10 as depicted and explained with reference to FIG. 1 but loaded with different cargo. From this view, it can be seen that this exemplary cargo space 20 includes four boundaries 22, a first lateral boundary 22-1, a second lateral boundary 22-2 opposite from the first lateral boundary 22-1, a rear boundary 22-3, and a front boundary 22-4. Other cargo spaces may include other boundary configurations, depending on for example shape and/or size. In this example the sensor 30 is arranged to monitor the front boundary 22-4 for any cargo 24 that is moved beyond a threshold distance with respect to the cargo space 20. As discussed above, other threshold distances, for example threshold distances being set within the cargo space 20, may involve sensors being arranged within the cargo space 20 for effective monitoring.

Generally, the threshold distance can correspond exactly to the physical boundary 22-4, i.e. 0 cm from the boundary 22-4 or be ±n cm from the physical boundary 22-4 where n is an arbitrary value such as 10, 40, 100, or the like. As discussed herein, this may vary depending on a variety of factors. The same as discussed here for this particular boundary 22-4 can be applicable for other boundaries 22 as well. Different or the same threshold distances may also be set for other boundaries 22. Moreover, the threshold distance can correspond to boundaries within the cargo space 20, for example relating to expected safe placements or delineations relating to compartments, shelves, fastening systems, or the like.

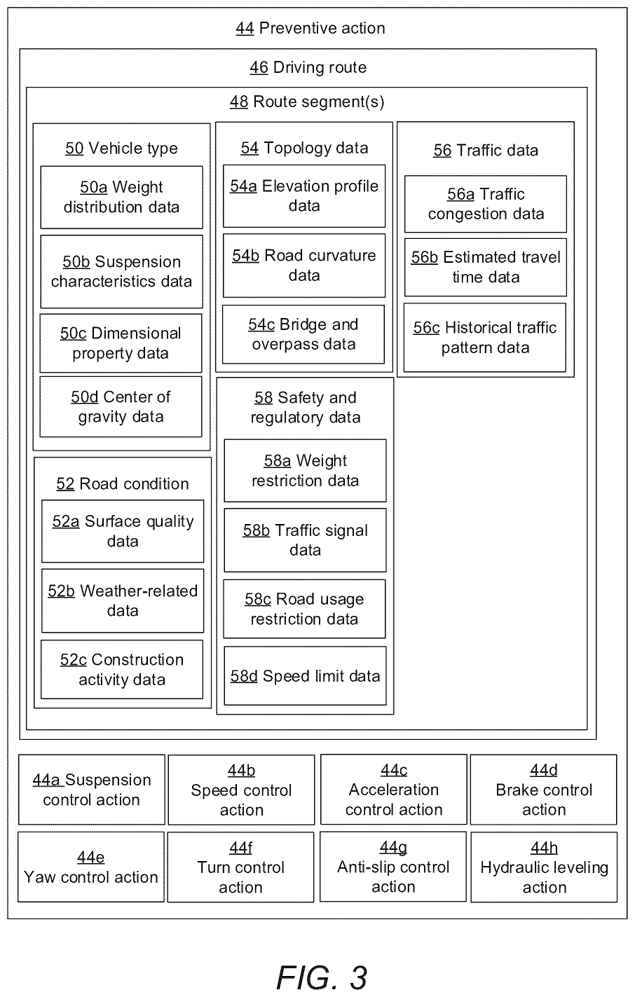

FIG. 3 is a schematic block diagram depicting various exemplary preventive actions 44. The preventive action 44 comprises a driving route 46. Therefore, determining what preventive action 44 is to be carried out based on the cargo movement is directly related to a particular driving route 46 where the vehicle 10 is or will be operating.

The processing circuitry 102 may be configured to determine the driving route 46 by at least selecting or omitting one or more route segments 48 from the driving route 46. A route segment 48 may have any length, from shorter routes of just a few meters to longer routes of several tens or hundreds of kilometers. The purpose of this configuration of the processing circuitry 102 is to dynamically adjust the driving route 46 by incorporating or excluding specific route segments 48. This selective modification of the route is intended to stabilize the cargo 24 within the cargo space 20 by mitigating conditions that may cause cargo movement, ultimately preventing further displacement of the cargo with respect to the established threshold distance.

The selection or omission of a route segment 48 by the processing circuitry 102 can be based on a multitude of data inputs, some of which are illustrated in FIG. 3. This data-driven approach ensures that the driving route 46 is improved, preferably in real-time, for the safest and most efficient transport of cargo 24, taking into account the unique characteristics of the vehicle 10 and the cargo 24 it carries.

The selection or omission may be based on a vehicle type 50. The type 50 of vehicle being operated can influence the handling and stability characteristics of the transport and thus impact the route selection. The vehicle type 50 may indicate weight distribution data 504 which is about how the weight of the cargo 24 is distributed within the vehicle 10, which affects the balance and handling of the vehicle 10, particularly during maneuvers. The vehicle type 50 may indicate suspension characteristics data 50b, which pertains to the vehicle's 10 suspension system 11M This may be relevant for determining route segments 48 that the vehicle 10 can traverse without causing undue movement of the cargo 24. The vehicle type 50 may indicate dimensional property data 50c The dimensions of the vehicle 10 may limit passage through certain route segments 48 with for example height, width, or length restrictions. The vehicle type 50 may indicate center of gravity data 50d The location of the vehicle's 10 center of gravity can affect vehicle stability and the risk of cargo movement, especially in turns or on slopes.

The selection or omission may be based on a road condition 52. The purpose of incorporating road condition 52 into the determination of the driving route 46 is to ensure that the chosen path reduces the risk of cargo movement due to external road factors. By evaluating the current state of the roads, the processing circuitry 132 can make informed decisions about which route segments 48 to select or omit, which may enhance the safety and security of the cargo 24 during transit. The road condition 52 may indicate surface quality data 52a, which pertains to the condition of the road surface, such as the presence of potholes, uneven pavement, or debris, which can cause vibrations or jolts that may displace cargo 24. The road condition 52 may indicate weather-related data 52b which involves information regarding weather conditions like rain, snow, ice, or wind that can impact road traction and vehicle stability, and therefore influence route selection to avoid weather-compromised roads. The road condition 52 may indicate construction activity data 52c. Details about ongoing construction work along the route segment 48 including lane closures or detours, which could lead to unexpected stops or rough riding conditions that might shift the cargo 24.

The selection or omission may be based on topology data 54. The use of topology data 54 in the decision-making process for the driving route 46 is aimed at enhancing cargo safety by considering the physical layout and geographic features of potential route segments 48. The processing circuitry 102 utilizes this data to avoid route segments 48 that could increase the risk of cargo movement due to topological challenges. The topology data 54 may indicate elevation profile data 54a. This data provides information on the inclines and declines along route segments 48, enabling omission of paths that avoid steep gradients which could cause cargo 24 to shift, especially if not properly secured. The topology data 54 may indicate road curvature data 54b Information on the curvature of the roads may be relevant to consider for anticipating the lateral forces that might act on the cargo 24 during turns. Route segments 48 with gentler curves can thus be selected to maintain cargo stability. The topology data 54 may indicate bridge and overpass data 54c. Details about bridges and overpasses, including possible ramps, their structural characteristics and any weight or height restrictions, could influence route feasibility based on the vehicle's 10 and cargo's 24 dimensions and weight.

The selection or omission may be based on traffic data 56. Incorporating traffic data 56 into the route planning process allows the processing circuitry 132 to select or omit route segments 48 that could negatively impact the safe transport of cargo 24 due to traffic conditions. This data-driven approach may help in avoiding potential delays and reduces the likelihood of cargo movement caused by stop-and-go traffic or other congestion-related issues. The traffic data 56 may indicate traffic congestion data 56a reflecting real-time traffic conditions, such as congestion or accidents, which can lead to unexpected stops or slow-moving traffic that may cause cargo 24 to shift, especially for sensitive or improperly secured loads. The traffic data 56 may indicate estimated travel time data 56b. Information on the expected time to traverse various route segments 48, can aid in planning the most efficient route while also considering the urgency of the cargo delivery and the potential for traffic to affect the stability of the cargo 24. The traffic data 56 may indicate historical traffic pattern data 56c. Details about usual traffic flows based on time of day, day of the week, or specific events, can predict and circumvent known busy periods or bottlenecks that might otherwise increase the risk of cargo movement due to prolonged travel times or frequent adjustments in vehicle speed.

The selection or omission may be based on safety and regulatory data 58. The integration of safety and regulatory data 58 into the route planning may ensure that the driving route 46 complies with legal requirements and safety guidelines while also catering to the stability needs of the cargo 24. The processing circuitry 312 uses this information to navigate regulatory constraints and enhance the protection of the cargo 24 during transit. The safety and regulatory data 58 may indicate weight restriction data 58a. This data informs about a limit permissible weight for vehicles on certain roads, bridges, or areas, ensuring that the chosen route can legally accommodate the vehicle's 10 total weight, including cargo 24 thereby avoiding potential wrongly selected roads that can necessitate a rerouting and thus potential further cargo movement. The safety and regulatory data 58 may indicate traffic signal data 58b. Information concerning the location and operation of traffic signals can influence the flow of traffic and the vehicle's movement patterns, thus playing a role in reducing frequent stops and starts that may destabilize the cargo 24. The safety and regulatory data 58 may indicate road usage restriction data 58c Details about any restrictions on road use, such as those applicable to commercial vehicles or vehicles carrying hazardous materials, might dictate which roads are suitable for the vehicle to travel on with its specific type of cargo 24 thereby avoiding potential wrongly selected roads that can necessitate a rerouting and thus potential further cargo movement. The safety and regulatory data 58 may indicate speed limit data 58d. The legal speed limits for different segments of the route, can affect the time of travel and the dynamic forces acting on the cargo 24. Adhering to speed limits is not only a legal necessity but also a factor in preventing cargo movement due to acceleration or deceleration.

Further shown in FIG. 3 are other exemplary control actions serving as preventive actions 44. These may be carried out one by one, simultaneously, as a consequence of selecting or omitting any of the route segments 48 as discussed above, or the like. These control actions are carried out for counteracting further movement of the cargo 24, and preferably also for repositioning the cargo 2 within the acceptable limits defined by the threshold distance. The preventive action 44 may encompass various vehicle control strategies aimed at stabilizing the cargo 24 once the processing circuitry 102 detects that it has moved with respect to the threshold distance with respect to the cargo space 24.

The preventive action 44 may be a suspension control action 44a If the sensor 30 indicates that the cargo 24 is tilting or shifting due to e.g. uneven road surfaces, the suspension control action 44a can be initiated by adjusting the suspension system 11M For example, the suspension system 110 could stiffen the suspension on one side of the vehicle 10 to counteract a detected lean, or it could raise the suspension on one end to redistribute cargo weight more evenly.

The preventive action 44 may be a speed control action 44b. Upon detecting that cargo movement is correlated with the vehicle's 10 speed, the speed control action 44b can slow down or increase the speed of the vehicle 10 to reduce the forces acting on the cargo 24. For instance, if the cargo 24 shifts forward during rapid deceleration, the system could maintain a steadier, slower speed to limit forward cargo movement.

The preventive action 44 may be an acceleration control action 44c If rapid acceleration is causing cargo 24 to shift backward, the acceleration control action 44c can modulate the throttle to increase the vehicle's 10 speed more gradually. Conversely, if deceleration is causing issues, a smoother, controlled braking can be ensured to prevent cargo 24 from lurching forward.

The preventive action 44 may be a brake control action 44d In a scenario where hard braking is leading to cargo 24 shifting towards the front of the cargo space 20, the brake control action 44d could engage the braking system 112 to apply brakes in a more modulated fashion, reducing the risk of sudden cargo movement.

The preventive action 44 may be a yaw control action 44e If cargo 24 is moving laterally during e.g. turning maneuvers, the yaw control action 44e could activate the stability system 134 to adjust the vehicle's 10 yaw movement, helping to keep the cargo 24 stable through careful management of the vehicle's 10 dynamic balance.

The preventive action 44 may be a turn control action 44f. When turning is causing cargo 24 to slide or tip, the turn control action 44f could involve the steering system 16 to adjust the angle or speed of the turn. This might mean taking wider turns or reducing speed before and during a corner to lower lateral forces on the cargo 24.

The preventive action 44 may be an anti-slip control action 44g. If the cargo 24 is moving due to wheel slip, perhaps on icy roads, the anti-slip control action 44g could activate the traction control system 118. This system could modulate power to the wheels to prevent slippage and the resultant jerking movements that can shift cargo 24.

The preventive action 44 may be a hydraulic leveling action 44h For cargo 24 that is moving because of the vehicle's 10 angle, such as when driving on a slope, the hydraulic leveling action 44h could adjust the hydraulic system 12 to level out the cargo space 2Q thereby preventing gravity from causing the cargo 24 to slide or roll.

Each of the above-mentioned preventive actions 44 is a response tailored to the type of cargo movement detected and the associated risks assessed by the processing circuitry 102, working in tandem to maintain the cargo 24 securely within the cargo space 20 and prevent it from moving further with respect to safe parameters.

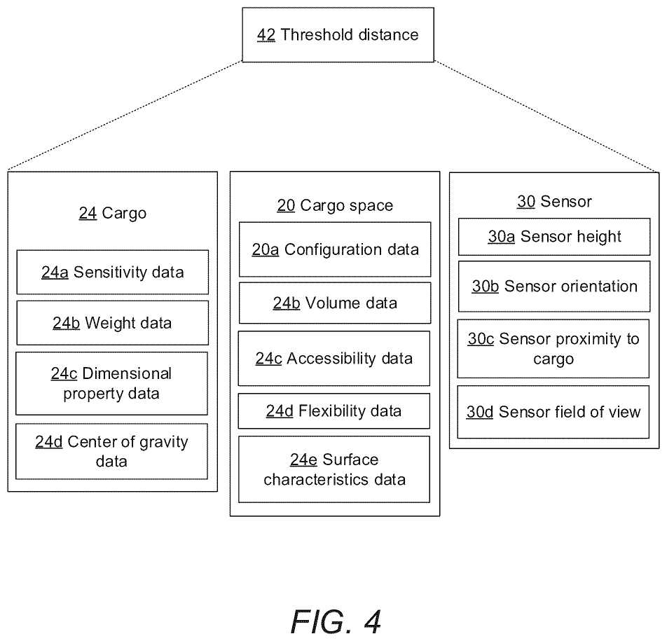

FIG. 4 shows exemplary data upon which the threshold distance 42 can be based. Generally, the threshold distance 42 can be set based on a type of cargo 24, a type of cargo space 20, and a mounting position of the sensor 30.

The type of cargo 24 may indicate one or more of sensitivity data 24a, weight data 24b, dimensional property data 24c and center of gravity data 24d Safer limits can thus be set based on how sensitive the items are (e.g. hazardous goods are generally more sensitive which can warrant a lower threshold distance 42). Moreover, heavier or more massive cargo items may require a larger threshold distance 42 to account for the increased inertia and the forces required to move such items, ensuring that the preventive actions 44 are not triggered by normal vehicle motion that would not significantly affect heavier cargo. In addition, volume, height, length, and width of the cargo 24 can affect how cargo 24 interacts with the available cargo space 20 and how it might move or shift. Furthermore, a center of gravity of the cargo 24 can be a factor to consider; a higher center of gravity could mean the cargo is more prone to tipping or toppling, requiring a smaller threshold distance 42 to trigger preventive actions 44 more quickly to ensure stability. The type of cargo 24 can relate to one or more individual pieces of cargo 24.

The type of cargo space 20 may indicate one or more of configuration data 20a, volume data 21b, accessibility data 20c, flexibility data 20d, and surface characteristics data 20e Different configurations, such as shelving, partitioning, or open spaces, influence how cargo 24 is stored and how it may shift within the cargo space 20. Moreover, the overall dimensions and volume of the cargo space 20 determine how much room the cargo has to move. A larger cargo space 20 might allow for a larger threshold distance 42 before preventive actions 44 are triggered. In addition, how the cargo space 20 is accessed, for example, through rear doors, side doors, or a liftgate, can influence the direction and likelihood of cargo 24 movement. Furthermore, the presence of adjustable components within the cargo space 20, such as movable dividers or tie-down points, can impact the stability of the cargo 24. In addition, the materials lining the cargo space 20, such as non-slip flooring or padded walls, can affect the movement of cargo 24 and thus the appropriate threshold distance 42.

The mounting position of the sensor 30 may indicate one or more of sensor height 304 sensor orientation 301 sensor proximity 30c to the cargo 24 or cargo space 20, and sensor field of view 30d Sensors 30 mounted at different outside of the cargo space 20 may detect movement differently; a sensor closer certain boundaries 22 might have a larger threshold distance 42 for detecting lateral movement of cargo 24 than one mounted further away, and similar can be envisaged by height of the sensor 30. In addition, the angle at which the sensor is mounted can affect its field of view and sensitivity to movement in specific directions (forward, backward, lateral, etc.). Furthermore, the field of view can determine how much of the cargo space 20 it can monitor at once, affecting the threshold distance 42 based on the coverage area.

Other examples not shown in FIG. 3 may be envisaged upon which the threshold distance 42 can be based, such as operating conditions of the vehicle 10, ambient conditions, safety regulations, or the like.

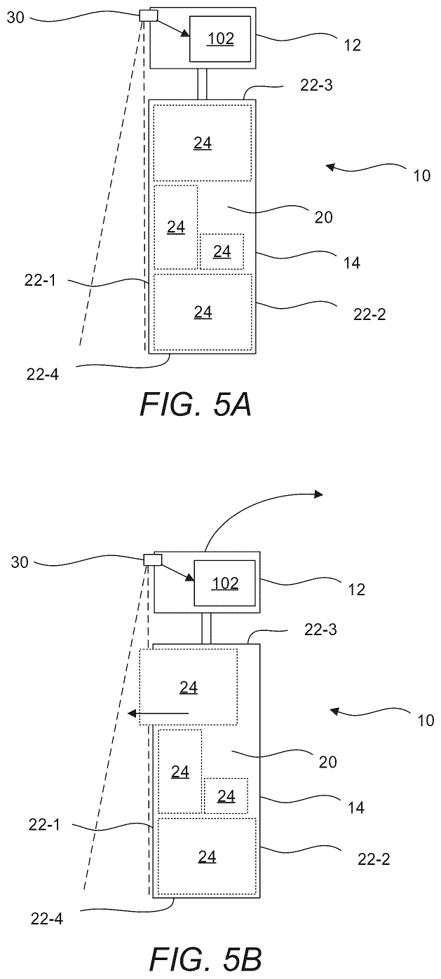

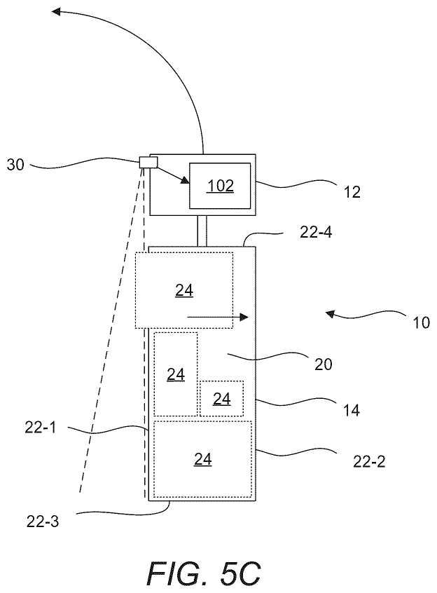

FIGS. 5A-C show an exemplary operational scenario of a vehicle 10 based on some control approaches discussed herein. In this example the vehicle 10 comprises a sensor 30. The sensor 30 monitors a first lateral outer boundary 22-1 of the cargo space 20, and the threshold distance pertains to the first lateral outer boundary 22-1. The cargo space 20 accommodates four pieces of cargo 24.

FIG. 5A corresponds to a normal (and safe) vehicle operation. No cargo 24 is moved outside of the monitored first lateral outer boundary 22-1. In FIG. 5B, the vehicle 10 has taken a sharp right turn, as indicated by the arrow, causing a piece of cargo 24 to shift outside the threshold distance at the first lateral outer boundary 22-1. This movement is detected by the sensor 30. As a consequence, in FIG. 5C, a certain preventive action has been determined, causing at least partial control of the vehicle 10 such that it compensates by a left turn. This may for example be done by selecting a certain route segment that requires such a left turn for the vehicle 10 to maintain thereon.

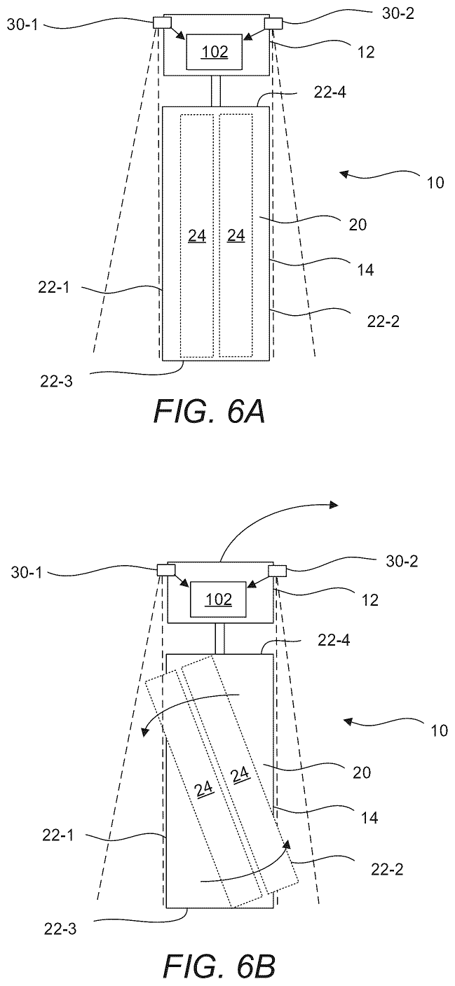

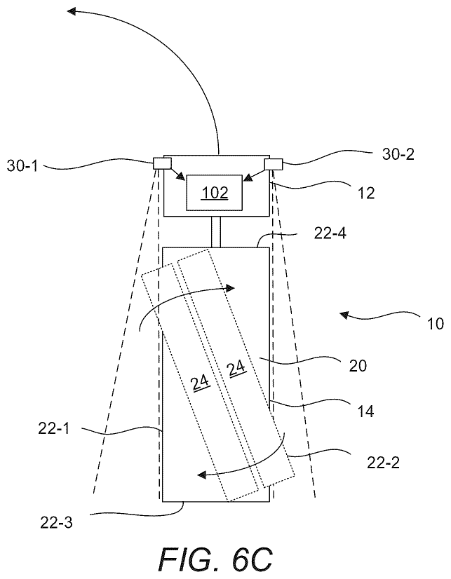

FIGS. 6A-C show another exemplary operational scenario of a vehicle 10 based on some control approaches discussed herein. In this example, the sensor 30 comprises a first sensor 30-1 and a second sensor 30-2 each monitoring a respective opposite lateral outer boundary 22-1, 22-2 of the cargo space 20. The threshold distance may be set the same or differently for the respective boundaries 22-1, 22-2. The cargo space 20 accommodates two pieces of cargo 24.

FIG. 6A corresponds to a normal (and safe) vehicle operation. No cargo 24 is moved outside of the monitored boundaries 22-1, 22-2. In FIG. 6B, the vehicle 10 has taken a sharp right turn, as indicated by the arrow, causing both pieces of cargo 24 to shift outside the threshold distance, one at the first threshold distance and another at the second threshold distance. This movement is detected by the respective sensors 30-1, 30-2. As a consequence, in FIG. 6C, a certain preventive action has been determined, causing at least partial control of the vehicle 10 such that it compensates by a left turn. This may for example be done by selecting a certain route segment that requires such a left turn for the vehicle 10 to maintain thereon.

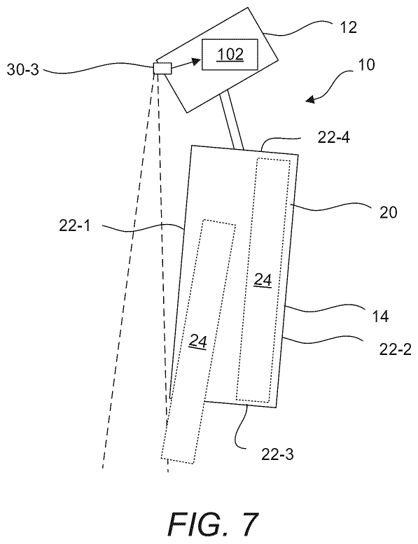

FIG. 7 is another operational scenario according to an example. Herein the sensor 30 comprises a rear sensor 30-3 monitoring a rear outer boundary 22-3 of the cargo space 20. To this end, a preventive action can also be taken in response to the rear sensor 30-3 indicating an unsafe movement of the cargo 24 as a result of the threshold distance pertaining to the rear outer boundary 22-3 being violated.

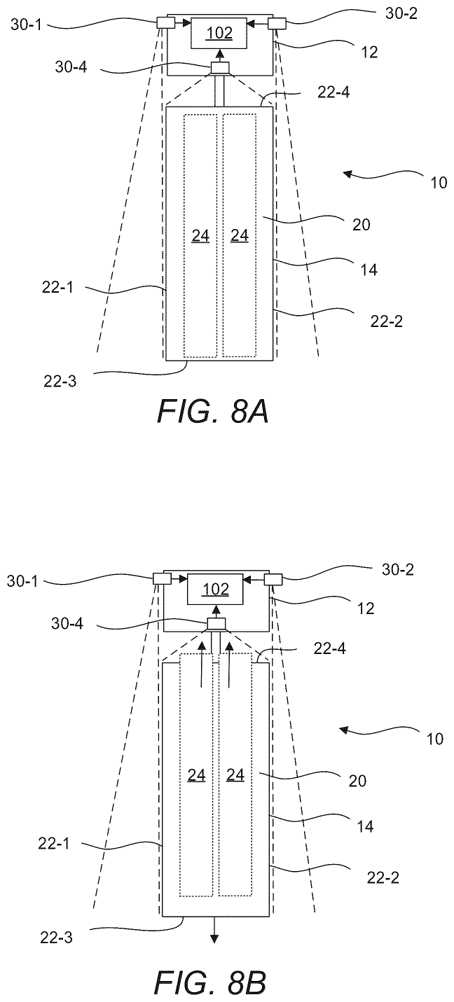

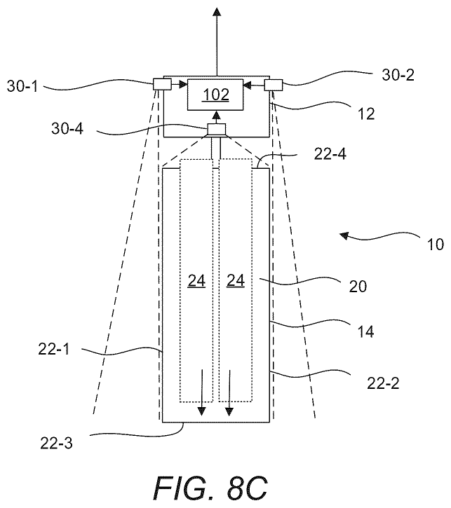

FIGS. 8A-C show another exemplary operational scenario of a vehicle 10 based on some control approaches discussed herein. In this example, the sensor 30 comprises a first sensor 30-1 and a second sensor 30-2 each monitoring a respective opposite lateral outer boundary 22-1, 22-2 of the cargo space 20, and a front sensor 30-4 monitoring a front outer boundary 22-4 of the cargo space 20. The threshold distance may be set the same or differently for the respective boundaries 22-1, 22-2, 22-4. The cargo space 20 accommodates two pieces of cargo 24.

FIG. 8A corresponds to a normal (and safe) vehicle operation. No cargo 24 is moved outside of the monitored boundaries 22-1, 22-2, 22-4. In FIG. 8B, the vehicle 10 has actuated the brakes, as indicated by the arrow, causing both pieces of cargo 24 to shift outside the threshold distance at the front outer boundary 22-4. This movement is detected by the front sensor 30-4. As a consequence, in FIG. 8C, a certain preventive action has been determined, causing at least partial control of the vehicle 10 such that it compensates by an accelerating action. This may for example be done by selecting a certain route segment that offers a higher speed limit.

While the examples of FIGS. 5-8 primarily discuss a sensor 30 arranged to monitor external boundaries of the cargo space 20, this shall not be construed as limiting to the scope of the present disclosure. As discussed above, internal boundaries of the cargo space 20 can also be considered. Moreover, the examples discussed above contextualize cargo movements in the X and Y planes from the point of view of the illustrations (i.e., top view). However, this is just for reasons of brevity, and it shall be appreciated that movements in the Z plane may additionally, or alternatively, be considered. This means that the system is equipped to detect and respond to cargo movements in lateral (X and Y planes) and/or vertical (Z-plane) directions. For example, suppose the vehicle 10 is turning sharply or changing lanes abruptly. The cargo might slide laterally across the floor of the cargo space, moving away from its intended position. If this lateral movement exceeds the predefined threshold distance in the X or Y plane, the system detects this as a risk. In another example the vehicle 10 may be traveling over hilly or uneven terrain. This could cause the cargo 24 to tilt or shift vertically, potentially leading to destabilization if the cargo 24 is not adequately secured. As such, the threshold distance may also pertain to the Z-plane. By considering movements in the X, Y, and/or Z planes, comprehensive monitoring of the cargo space 20 can be ensured. This approach allows for detecting shift, or tilt, that could signify an unsafe condition, regardless of the direction of movement.

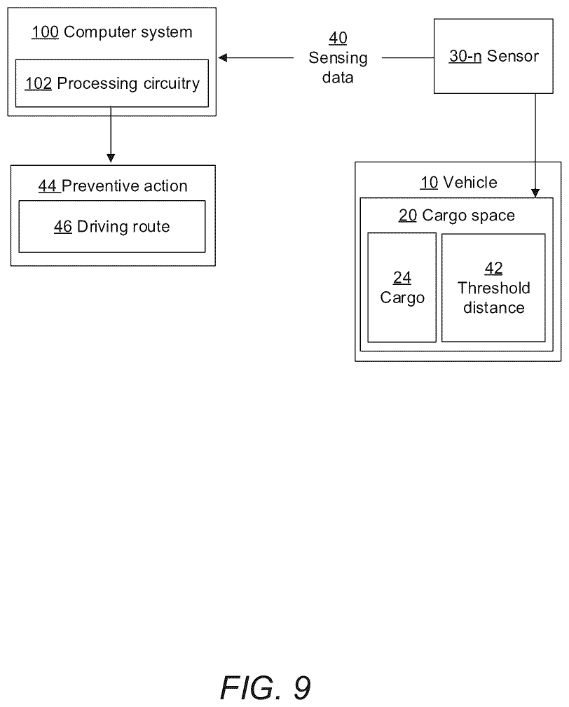

FIG. 9 is a schematic diagram of a computer system 100 for implementing examples disclosed herein. The computer system 10 comprises processing circuitry 12. The processing circuitry 102 is configured to obtain sensing data 40 from a sensor 30-n monitoring a cargo space 20 of a vehicle 10. The processing circuitry 102 is configured to determine, based on the sensing data 40, that at least a portion of a cargo 24 in the cargo space 20 is moved a threshold distance 42 of the cargo space 24 during operation of the vehicle 10. The processing circuitry 132 is configured to determine at least one preventive action 44 to be carried out by the vehicle 10 to prevent further movement of the cargo 24 with respect to the threshold distance 42, the at least one preventive action 44 comprising a driving route 46. The processing circuitry 312 is configured to control the vehicle 10 to at least partially carry out the at least one preventive action 44.

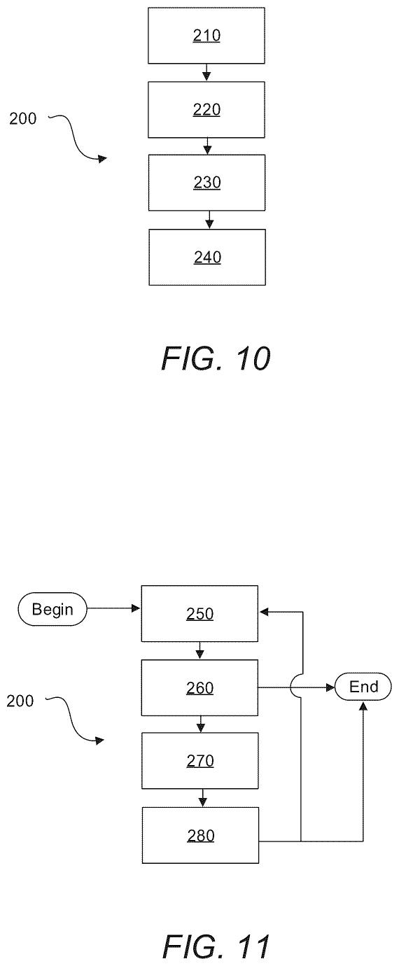

FIG. 10 is a flowchart of a computer-implemented method 200. The method 200 begins at step 21 by processing circuitry of a computer system, of obtaining sensing data from a sensor monitoring a cargo space of a vehicle. At step 220 the method 200 determines, by the processing circuitry, based on the sensing data, that at least a portion of a cargo in the cargo space is moved a threshold distance of the cargo space during operation of the vehicle. At 23Q the method determines, by the processing circuitry, at least one preventive action to be carried out by the vehicle to prevent further movement of the cargo with respect to the threshold distance, the at least one preventive action comprising a driving route. At 240, the method 200 controls, by the processing circuitry, the vehicle to at least partially carry out the at least one preventive action. In response to a successful carrying out of the preventive action, the method 200 terminates.

FIG. 31 is a flowchart of a computer-implemented method 200. The steps shown can be carried out following the initial steps 230, 220, 230, 240 outlined in the flowchart of method 200 as discussed with reference to FIG. 10. FIG. 11 highlights additional and optional steps 250, 260, 270, 280 of the method 200 to provide continuous monitoring and adaptive response capabilities. These additional steps 250, 260, 270, 280 can form an iterative feedback loop that continuously assesses the efficacy of the implemented preventive actions and adjusts them as necessary in real-time. The additional steps 250 to 280 can also be carried out by the processing circuitry.

At 250, the method 200 obtains updated sensing data from the sensor after implementing the initial preventive action. This can ensure that the system has real-time data on the position and movement of the cargo following the adjustments made to the vehicle's driving route or other preventive action at 240. At 260, the method re-evaluates the updated sensing data to determine if cargo movement has been successfully stabilized within the threshold distance of the boundaries of the cargo space. If the cargo is now stable and no longer poses a risk of moving beyond the safe boundaries, the process can be terminated, or the monitoring can continue at a regular interval to ensure ongoing safety. However, upon being determined that the initial preventive action was not sufficient to correct the risk, i.e., the cargo is still moving or has not yet stopped moving with respect to the threshold distance, the method can proceed to step 270 which involves determining an additional preventive action. This could involve further modifying the driving route, adjusting the vehicle's speed, changing the suspension settings, or implementing other preventive actions to enhance cargo stability as mentioned herein. At 280, the method 200 controls the vehicle to carry out this additional preventive action. After implementing the additional preventive action, the method 200 can terminate, or loop back to step 250 to continue to obtain and analyze updated sensing data to assess the effectiveness of the newly implemented measures.

The method 200 described above, comprising steps 250 to 280, can continue iteratively until the cargo is confirmed to be securely maintained within the defined threshold distance, ensuring that all potential risks are mitigated and the cargo's safety is continuously monitored and maintained throughout the vehicle's operation. This dynamic and responsive approach can allow the system to adapt to varying conditions and cargo behaviors, providing a robust solution to cargo safety in transit.

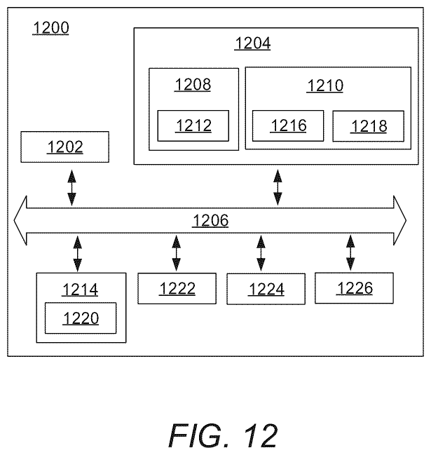

FIG. 12 is a schematic diagram of a computer system 1200 for implementing examples disclosed herein. The computer system 1200 is adapted to execute instructions from a computer-readable medium to perform these and/or any of the functions or processing described herein. The computer system 1200 may be connected (e.g., networked) to other machines in a LAN, an intranet, an extranet, or the Internet. While only a single device is illustrated, the computer system 1200 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller A rea Network (CAN) bus, etc.

The computer system 1200 may comprise at least one computing device or electronic device capable of including firmware, hardware, and/or executing software instructions to implement the functionality described herein. The computer system 1200 may include processing circuitry 122 (e.g., processing circuitry including one or more processor devices or control units), a memory 120 and a system bus 1206. The computer system 1200 may include at least one computing device having the processing circuitry 1202. The system bus 1206 provides an interface for system components including, but not limited to, the memory 1204 and the processing circuitry 1202. The processing circuitry 1202 may include any number of hardware components for conducting data or signal processing or for executing computer code stored in memory 1204. The processing circuitry 1202 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1202 may further include computer executable code that controls operation of the programmable device.

The system bus 1206 may be any of several types of bus structures that may further interconnect to a memory bus (with or without a memory controller), a peripheral bus, and/or a local bus using any of a variety of bus architectures. The memory 1204 may be one or more devices for storing data and/or computer code for completing or facilitating methods described herein. The memory 1204 may include database components, object code components, script components, or other types of information structure for supporting the various activities herein. Any distributed or local memory device may be utilized with the systems and methods of this description. The memory 12 may be communicably connected to the processing circuitry 1202 (e.g., via a circuit or any other wired, wireless, or network connection) and may include computer code for executing one or more processes described herein. The memory 12 may include non-volatile memory 1208 (e.g., read-only memory (ROM), erasable programmable read-only memory (EPROM), electrically erasable programmable read-only memory (EE PROM), etc.), and volatile memory 1210 (e.g., random-access memory (RAM)), or any other medium which can be used to carry or store desired program code in the form of machine-executable instructions or data structures and which can be accessed by a computer or other machine with processing circuitry 1202. A basic input/output system (BIOS) 1212 may be stored in the non-volatile memory 1208 and can include the basic routines that help to transfer information between elements within the computer system 1200.

The computer system 120 may further include or be coupled to a non-transitory computer-readable storage medium such as the storage device 1214 which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1214 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1214 and/or in the volatile memory 1210, which may include an operating system 1216 and/or one or more program modules 1218. All or a portion of the examples disclosed herein may be implemented as a computer program 1220 stored on a transitory or non-transitory computer-usable or computer-readable storage medium (e.g., single medium or multiple media), such as the storage device 1234 which includes complex programming instructions (e.g., complex computer-readable program code) to cause the processing circuitry 1202 to carry out actions described herein. Thus, the computer-readable program code of the computer program 12 can comprise software instructions for implementing the functionality of the examples described herein when executed by the processing circuitry 1220. In some examples, the storage device 1214 may be a computer program product (e.g., readable storage medium) storing the computer program 1220 thereon, where at least a portion of a computer program 1220 may be loadable (e.g., into a processor) for implementing the functionality of the examples described herein when executed by the processing circuitry 1222. The processing circuitry 1202 may serve as a controller or control system for the computer system 1200 that is to implement the functionality described herein.

The computer system 1220 may include an input device interface 1222 configured to receive input and selections to be communicated to the computer system 1200 when executing instructions, such as from a keyboard, mouse, touch-sensitive surface, etc. Such input devices may be connected to the processing circuitry 1202 through the input device interface 1222 coupled to the system bus 1206 but can be connected through other interfaces, such as a parallel port, an Institute of Electrical and Electronic Engineers (IEEE) 1394 serial port, a Universal Serial Bus (USB) port, an IR interface, and the like. The computer system 1200 may include an output device interface 1224 configured to forward output, such as to a display, a video display unit (e.g., a liquid crystal display (LCD) or a cathode ray tube (CRT)). The computer system 1200 may include a communications interface 1226 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system (100; 1200) comprising processing circuitry (102; 1202) configured to: obtain sensing data (40) from a sensor (30-n) monitoring a cargo space (20) of a vehicle (10); determine, based on the sensing data (40), that at least a portion of a cargo (24) in the cargo space (20) is moved a threshold distance (42) of the cargo space (24) during operation of the vehicle (10); determine at least one preventive action (44) to be carried out by the vehicle (10) to prevent further movement of the cargo (24) with respect to the threshold distance (42), the at least one preventive action (44) comprising a driving route (46); and control the vehicle (10) to at least partially carry out the at least one preventive action (44).

Example 2: The computer system (100; 1200) of Example 1, wherein the processing circuitry (102; 1202) is configured to determine the driving route (46) by at least selecting or omitting one or more route segments (48) from the driving route (46).

Example 3: The computer system (100; 1200) of Example 2, wherein the processing circuitry (102; 1202) is further configured to at least select or omit said one or more route segments (48) based on a vehicle type (50) of the vehicle (10), the vehicle type (50) indicating one or more of weight distribution data (50a), suspension characteristics data (50b), dimensional property data (50c), and center of gravity data (50d).

Example 4: The computer system (100; 1200) of any of Examples 2-3, wherein the processing circuitry (102; 1202) is further configured to at least select or omit said one or more route segments (48) based on a road condition (52) for the driving route (46), the road condition (52) indicating one or more of surface quality data (52a), weather-related data (52b) and construction activity data (52c).

Example 5: The computer system (100; 1200) of any of Examples 2-4, wherein the processing circuitry (102; 1202) is further configured to at least select or omit said one or more route segments (48) based on topology data (54) for the driving route (46), the topology data (54) indicating one or more of elevation profile data (54a), road curvature data (54b), and bridge and overpass data (54c).

Example 6: The computer system (100; 1200) of any of Examples 2-5, wherein the processing circuitry (102; 1202) is further configured to at least select or omit said one or more route segments (48) based on traffic data (56) for the driving route (46), the traffic data (56) indicating one or more of current traffic congestion data (56a), estimated travel time data (56b), and historical traffic pattern data (56c).

Example 7: The computer system (100; 1200) of any of Examples 2-6, wherein the processing circuitry (102; 1202) is further configured to at least select or omit said one or more route segments (48) based on safety and regulatory data (58) for the driving route (46), the safety and regulatory data (58) indicating one or more of weight restriction data (58a), traffic signal data (58b), road usage restriction data (58c), and speed limit data (58d).

Example 8: The computer system (100; 1200) of any of Examples 1-7, wherein the at least one preventive action (44) comprises a suspension control action (44a), a speed control action (44b), an acceleration control action (44c), a brake control action (44d), a yaw control action (44e), a turn control action (44f), an anti-slip control action (44g), or a hydraulic leveling action (44h).

Example 9: The computer system (100; 1200) of Example 8, the preventive action (44) being a suspension control action (44a), wherein controlling the vehicle (10) to at least partially carry out the suspension control action (44a) comprises controlling a suspension system (110) for counteracting further movement of the cargo (24).

Example 10: The computer system (100; 1200) of any of Examples 8-9, the preventive action (44) being a speed control action (44b), wherein controlling the vehicle (10) to at least partially carry out the speed control action (44b) comprises adjusting the speed of the vehicle (10) for counteracting further movement of the cargo (24).

Example 11: The computer system (100; 1200) of any of Examples 8-10, the preventive action (44) being an acceleration control action (44c), wherein controlling the vehicle (10) to at least partially carry out the acceleration control action (44c) comprises adjusting the rate of increase in the speed of the vehicle (10) for counteracting further movement of the cargo (24).

Example 12: The computer system (100; 1200) of any of Examples 8-11, the preventive action (44) being a brake control action (44d), wherein controlling the vehicle (10) to at least partially carry out the brake control action (44d) comprises controlling a braking system (112) of the vehicle (10) for counteracting further movement of the cargo (24).

Example 13: The computer system (100; 1200) of any of Examples 8-12, the preventive action (44) being a yaw control action (44e), wherein controlling the vehicle (10) to at least partially carry out the yaw control action (44e) comprises controlling a stability system (114) of the vehicle (10) for counteracting further movement of the cargo (24).

Example 14: The computer system (100; 1200) of any of Examples 8-13, the preventive action (44) being a turn control action (44f), wherein controlling the vehicle (10) to at least partially carry out the turn control action (44f) comprises controlling a steering system (116) of the vehicle (10) for counteracting further movement of the cargo (24).

Example 15: The computer system (100; 1200) of any of Examples 8-14, the preventive action (44) being an anti-slip control action (44g), wherein controlling the vehicle (10) to at least partially carry out the anti-slip control action (44g) comprises controlling a traction control system (118) of the vehicle (10) for counteracting further movement of the cargo (24).

Example 16: The computer system (100; 1200) of any of Examples 8-15, the preventive action (44) being a hydraulic leveling action (44h), wherein controlling the vehicle (10) to at least partially carry out the hydraulic leveling action (44h) comprises controlling a hydraulic system (120) of the vehicle (10) for counteracting further movement of the cargo (24).

Example 17: The computer system (100; 1200) of any of Examples 1-16, wherein the processing circuitry (102; 1202) is further configured to, in response to determining that at least a portion of the cargo (24) in the cargo space (20) is moved a threshold distance (42) with respect to the cargo space (24) during operation of the vehicle (10), cause emission of one or more of an audible alert (32a), visual cue (32b) and tactile indicator (32c).

Example 18: The computer system (100; 1200) of any of Examples 1-17, wherein the processing circuitry (102; 1202) is configured to control the vehicle (10) to at least partially carry out the at least one preventive action (44) by causing autonomous driving of the vehicle (10) to follow the determined driving route (46).

Example 19: The computer system (100; 1200) of any of Examples 1-18, wherein the processing circuitry (102; 1202) is configured to control the vehicle (10) to at least partially carry out the at least one preventive action (44) by transmitting the driving route (46) to a driver of the vehicle (10) via a user interface (18).

Example 20: The computer system (100; 1200) of any of Examples 1-19, wherein the processing circuitry (102; 1202) is further configured to determine at least one preventive action (44) to be carried out by the vehicle (10) to prevent further movement of the cargo (24) with respect to the threshold distance by identifying a discrepancy between reference sensing data (41), indicating an expected safe placement of the cargo (24), and the sensing data (40).

Example 21: The computer system (100; 1200) of any of Examples 1-20, wherein the sensor (30-n) comprises a first sensor (30-1) monitoring a first lateral outer boundary (22-1) of the cargo space (20), wherein the threshold distance (42) pertains to the first lateral outer boundary (22-1).

Example 22: The computer system (100; 1200) of Example 21, wherein the sensor (30-n) comprises the first sensor (30-1) and a second sensor (30-2), the second sensor (30-2) monitoring a second lateral outer boundary (22-2) of the cargo space (20) different from the first lateral outer boundary (22-1), wherein the threshold distance (42) pertains to the first and second lateral outer boundaries (22-1, 22-2).

Example 23: The computer system (100; 1200) of any of Examples 1-22, wherein the sensor (30-n) comprises a rear sensor (30-3) monitoring a rear outer boundary (22-3) of the cargo space (20), wherein the threshold distance (42) pertains to the rear outer boundary (22-3).

Example 24: The computer system (100; 1200) of any of Examples 1-23, wherein the sensor (30-n) comprises a front sensor (30-4) monitoring a front outer boundary (22-4) of the cargo space (20), wherein the threshold distance (42) pertains to the front outer boundary (22-4).

Example 25: The computer system (100; 1200) of any of Examples 1-24, wherein the processing circuitry (102; 1202) is further configured to set the threshold distance (42) based a type of cargo (24), the type of cargo (24) indicating one or more of a sensitivity data (24a), weight data (24b), dimensional property data (24c), and center of gravity data (24d).

Example 26: The computer system (100; 1200) of any of Examples 1-25, wherein the processing circuitry (102; 1202) is further configured to set the threshold distance (42) based on a type of cargo space (20), the type of cargo space (20) indicating one or more of configuration data (20a), volume data (20b), accessibility data (20c), flexibility data (20d) and surface characteristics data (20e).

Example 27: The computer system (100; 1200) of any of Examples 1-26, wherein the processing circuitry (102; 1202) is further configured to set the threshold distance (42) based on a mounting position of the sensor (30-n), the mounting position indicating one or more of sensor height data (30a), sensor orientation data (30b), sensor proximity data (30c) to the cargo (24), and sensor field of view data (30d).

Example 28: The computer system (100; 1200) of any of Examples 1-27, wherein the sensor (30-n) is a camera, and wherein the sensing data (40) comprises image data of the cargo space (20) captured by the camera.

Example 29: A vehicle (10) comprising the computer system (100; 1200) of any of Examples 1-28.

Example 30: The vehicle (10) of Example 29, being a vehicle combination comprising a tractor unit (12) and at least one trailing unit (14), a rigid truck, or a combination thereof.

Example 31: The vehicle (10) of Example 30, wherein the tractor unit (12) comprises the sensor (30-n) according to any of Examples 1-28 being mounted to an exterior of the tractor unit (12) or a front portion of the rigid truck, and monitoring a cargo space (20) of the at least one trailing unit (14) or a rear portion of the rigid truck.

Example 32: The vehicle (10) of Example 31, wherein the at least one trailing unit (14), or the rear portion of the rigid truck, is an open trailer.

Example 33: The vehicle (10) of Example 32, wherein the open trailer comprises a tarpaulin adapted to enclose at least portions of a cargo space (20).

Example 34: A computer-implemented method (200), comprising: obtaining (210), by processing circuitry (102; 1202) of a computer system (100; 1200), sensing data (40) from a sensor (30-n) monitoring a cargo space (20) of a vehicle (10); determining (220), by the processing circuitry (102; 1202), based on the sensing data (40), that at least a portion of a cargo (24) in the cargo space (20) is moved a threshold distance (42) of the cargo space (24) during operation of the vehicle (10); determining (230), by the processing circuitry (102; 1202), at least one preventive action (44) to be carried out by the vehicle (10) to prevent further movement of the cargo (24) with respect to the threshold distance, the at least one preventive action (44) comprising a driving route (46); and controlling (240), by the processing circuitry (102; 1202), the vehicle (10) to at least partially carry out the at least one preventive action (44).

Example 35: A computer program product comprising program code for performing, when executed by processing circuitry (102; 1202), the method (200) of Example 34.

Example 36: A non-transitory computer-readable storage medium comprising instructions, which when executed by processing circuitry (102; 1202), cause the processing circuitry (102; 1202) to perform the method (200) of Example 34.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain sensing data from a sensor monitoring a cargo space of a vehicle;
determine, based on the sensing data, that at least a portion of a cargo in the cargo space is moved a threshold distance of the cargo space during operation of the vehicle;
determine at least one preventive action to be carried out by the vehicle to prevent further movement of the cargo with respect to the threshold distance, the at least one preventive action comprising a driving route; and
control the vehicle to at least partially carry out the at least one preventive action.

2. The computer system of claim 1, wherein the processing circuitry is configured to determine the driving route by at least selecting or omitting one or more route segments from the driving route.

3. The computer system of claim 2, wherein the processing circuitry is further configured to at least select or omit said one or more route segments based on a vehicle type of the vehicle.

4. The computer system of claim 2, wherein the processing circuitry is further configured to at least select or omit said one or more route segments based on one or more of a road condition, topology data, traffic data, and safety and regulatory data, for the driving route.

5. The computer system of claim 1, wherein the at least one preventive action comprises a suspension control action, a speed control action, an acceleration control action, a brake control action, a yaw control action, a turn control action, an anti-slip control action, or a hydraulic levelling action, wherein controlling the vehicle to at least partially carry out the preventive action causes counteraction of further movement of the cargo.

6. The computer system of claim 1, wherein the processing circuitry is further configured to, in response to determining that at least a portion of the cargo in the cargo space is moved a threshold distance with respect to the cargo space during operation of the vehicle, cause emission of one or more of an audible alert, visual cue and tactile indicator.

7. The computer system of claim 1, wherein the processing circuitry is configured to control the vehicle to at least partially carry out the at least one preventive action by causing autonomous driving of the vehicle to follow the determined driving route.

8. The computer system of claim 1, wherein the processing circuitry is configured to control the vehicle to at least partially carry out the at least one preventive action by transmitting the driving route to a driver of the vehicle via a user interface.

9. The computer system of claim 1, wherein the processing circuitry is further configured to determine at least one preventive action to be carried out by the vehicle to prevent further movement of the cargo with respect to the threshold distance by identifying a discrepancy between reference sensing data, indicating an expected safe placement of the cargo, and the sensing data.

10. The computer system of claim 1, wherein the sensor monitors an outer boundary of the cargo space, wherein the threshold distance pertains to the outer boundary.

11. The computer system of claim 10, wherein the sensor comprises a plurality of sensors, each one of the plurality of sensors monitoring a respective outer boundary comprising at least two of a first outer lateral boundary, a second outer lateral boundary different from the first outer lateral boundary, a rear outer boundary, and a front outer boundary, wherein the threshold distance pertains to each of the monitored outer boundaries.

12. The computer system of claim 1, wherein the processing circuitry is further configured to set the threshold distance based a type of cargo, the type of cargo indicating one or more of a sensitivity data, weight data, dimensional property data, and center of gravity data.

13. The computer system of claim 1, wherein the processing circuitry is further configured to set the threshold distance based on a type of cargo space, the type of cargo space indicating one or more of configuration data, volume data, accessibility data, flexibility data and surface characteristics data.

14. The computer system of claim 1, wherein the processing circuitry is further configured to set the threshold distance based on a mounting position of the sensor, the mounting position indicating one or more of sensor height data, sensor orientation data, sensor proximity data to the cargo, and sensor field of view data.

15. The computer system of claim 1, wherein the sensor is a camera, and wherein the sensing data comprises image data of the cargo space captured by the camera.

16. A vehicle comprising the computer system of claim 1.

17. The vehicle of claim 16, being a vehicle combination comprising a tractor unit and at least one trailing unit, a rigid truck, or a combination thereof;
wherein the tractor unit comprises a sensor being mounted to an exterior of the tractor unit or a front portion of the rigid truck, the sensor monitoring a cargo space of the at least one trailing unit or a rear portion of the rigid truck;
wherein the at least one trailing unit, or the rear portion of the rigid truck, is an open trailer; and
wherein the open trailer comprises a tarpaulin adapted to enclose at least portions of a cargo space.

18. A computer-implemented method, comprising:
obtaining, by processing circuitry of a computer system, sensing data from a sensor monitoring a cargo space of a vehicle;
determining, by the processing circuitry, based on the sensing data, that at least a portion of a cargo in the cargo space is moved a threshold distance of the cargo space during operation of the vehicle;
determining, by the processing circuitry, at least one preventive action to be carried out by the vehicle to prevent further movement of the cargo with respect to the threshold distance, the at least one preventive action comprising a driving route; and
controlling, by the processing circuitry, the vehicle to at least partially carry out the at least one preventive action.

19. A computer program product comprising program code for performing, when executed by processing circuitry, the method of claim 18.

20. A non-transitory computer-readable storage medium comprising instructions, which when executed by processing circuitry, cause the processing circuitry to perform the method of claim 18.
